(19) United States
(12) Patent Application Publication
(10) Pub. No.: US 2009/0006163 A1
(43) Pub. Date: Jan. 1, 2009

(54) Method and System for Allocating Member Compensation

(75) Inventors: Arun V. Subramanian, Madurai (IN); Bruce Jones, Jersey City, NJ (US); Marilyn Law, Glen Ridge, NJ (US); Manoj Agarwol, Bayonne, NJ (US); Linda Matkowski, Clifton, NJ (US); Amy Okurowski, West Islip, NY (US); Kathy Sorensen, South Amboy, NJ (US); Donna Asaro, New York, NY (US)

Correspondence Address: MORGAN LEWIS & BOCKIUS LLP, 1111 PENNSYLVANIA AVENUE NW, WASHINGTON, DC, 20004, US

(73) Assignee: Lehman Brothers Inc., New york, NY (US)

(21) Appl. No.: 11/771,266

(22) Filed: Jun. 29, 2007

(51) Int. Cl. G06Q 30/00

(52) U.S. Cl. 705/8; 705/11

(57) ABSTRACT

Compensation to be paid to one or more members of an organization is determined. The organization has members organized in a hierarchical structure comprising first-level members, second-level members, and third-level members. A pool of money to be paid to the members in the organization as compensation is identified. A first portion of the pool is assigned to a first-level member. Then the first-level member determines a second portion of the pool from the first portion to be distributed to members below the first-level member and/or an amount from the first portion to be paid to one or more members below the first-level member. The second portion is assigned to the second-level member. Then the second-level member determines a third portion of the pool to be distributed to members below the second-level member and/or an amount from the second portion to be paid to members below the second-level member.

### FIELD OF THE INVENTION

The present invention relates to methods and systems for determining and controlling allocation of member compensation, such as bonuses.

### BACKGROUND OF THE INVENTION

In many organizations, such as financial services companies, a large part of an employee's compensation is bonus-based. As a general matter, managers are charged with allocating bonus money to their direct reports. However, problems arise when mangers allocate more bonus money than is available. In addition, higher level managers may want to have access to, and possibly control over, money allocated as bonuses to lower-level employees within their reporting structure. Finally, the window of time within which bonuses must be determined and allocated is often short; many important decisions must be made within this time period.

Thus, there is a need for an efficient method for determining and allocating bonus-based employee compensation, with improved transparency, that avoids overdraws.

### SUMMARY OF THE INVENTION

The present invention is directed to a method and system for determining compensation to be paid to one or more members of an organization. The organization is comprised of a plurality of members organized in accordance with a hierarchical structure comprising one or more first-level members, one or more second-level members below the first-level members in the hierarchical structure, and one or more third-level members below the second-level members in the hierarchical structure. A pool of money to be paid to the members in the organization as compensation is identified. At least a first portion of the pool is assigned to the first-level member. Upon being assigned the first portion, the first-level member determines a second portion of the pool from the first portion to be distributed to one or more members below the first-level member in the hierarchical structure and/or an amount from the first portion to be paid to one or more members below the first-level member in the hierarchical structure. The portion of the pool is assigned to the second-level member. Upon being assigned the second portion, the second-level member determines a third portion of the pool from the second portion to be distributed to one or more members below the second-level member in the hierarchical structure and/or an amount from the second portion to be paid to one or more members below the second-level member in the hierarchical structure. The third-level member is allocated the amount from the first portion and/or the amount from the second portion to be paid as compensation. The first-level member is provided view and/or edit access to the third portion and/or the amount from the second portion.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and, together with the description, serve to explain the principles of the invention.

In the drawings:

FIG. 1 is a diagram illustrating an exemplary system for carrying out the present invention;

FIGS. 2 through 19 are exemplary screen shots that may be used in connection with the present invention;

FIG. 20 is an exemplary database schema that may be used to structure data generated in accordance with the present invention; and

FIGS. 21A and 21B are diagrams illustrating an exemplary method of the present invention.

### DETAILED DESCRIPTION OF THE PREFERRED EMBODIMENTS

The invention relates to a software system developed to facilitate the management of compensation decisions within an organization and, in some embodiments, multiple divisions of the organization. While the examples described herein relate to bonus compensation, the invention is equally applicable to other types of compensation. Also, while the embodiments described herein refer to employees of an organization, the invention is equally applicable to all individuals within the organizational structure of an organization.

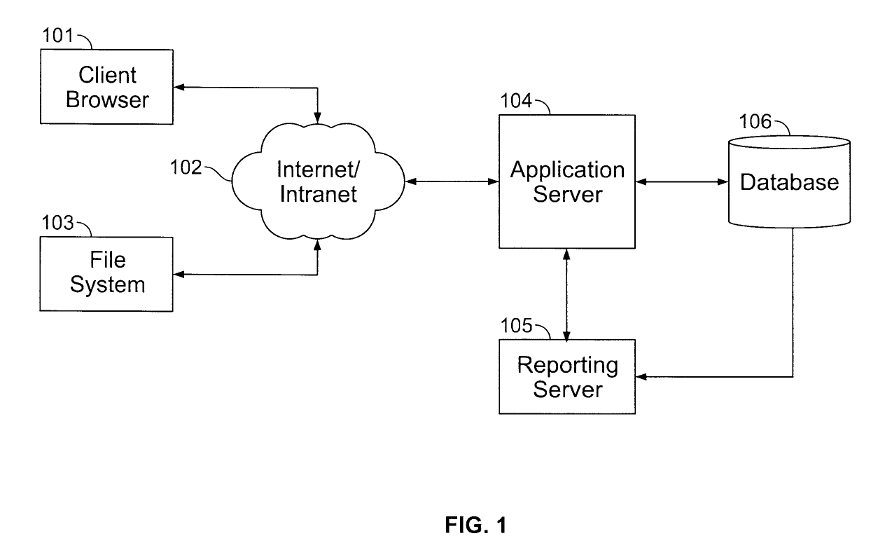

With reference to FIG. 1, an exemplary system diagram for carrying out the present invention is shown and described. Clients 101 may access the system via a network 102 (e.g., an intranet or the Internet). The application comprising the logic for running the application is housed in application server 104. Database 106 maintains the information inputted and generated as a result of using the application. In addition, in a preferred embodiment, such information is integrated in database 106 with basic human resources data to ensure accurate and real-time employee-related data display and update of bonus/salary decisions. The system also includes basic administrative features to assist human resource administrators in managing the overall bonus compensation distribution process. Reporting server 105 is used to generate reports. The user may download information to a file system 103.

The system and method described herein provide managers with the ability to distribute compensation money, e.g., bonus compensation money, to any of their direct reports within the organization and to distribute pools of employee bonus compensation money to direct report managers, as well as other managers within the organization. Pool Managers assign bonus pools to subordinate Pool Managers for their distribution to subordinate Pool Managers, who distribute to Bonus Managers, and so on, until all bonus pool money is distributed. Furthermore, Bonus Managers distribute bonus money to individual employees.

The system operates upon an infrastructure of employee data, manager-employee relationships data, and pool/bonus data. Employee data is pulled from databases associated with human resources applications, which contain the latest employee data, historical compensation values, and the latest currency exchange rates. Bonus-specific data is pulled from a database that contains information such as bonus values and manager reporting relationships.

The process is a top down process; that is, an initial bonus value is established at the top of the organization or division and then the bonus distributions cascade down the organization or division until all bonus money has been distributed. To keep the process orderly and accurate, business rules may be put in place to prevent managers from over-distributing their authorized bonus pools.

Various functionality is described herein for exemplary purposes; however, as will be apparent, not all of the functionality described herein need be included, and additional functionality may be added, within the scope of the present invention.

In many organizations, the bonus compensation distribution process is a once-per-year process. In a preferred embodiment, the inventive software is available to managers to distribute bonus money during a period of time that starts from the time the software is opened to managers for bonus data entry until the software is closed and is no longer available to managers for bonus data entry. The period of time between when the software is first opened until the software is closed for the last time is referred to herein as the Bonus Compensation Period. The Bonus Compensation Period can occur at multiple, various times throughout the year. The Bonus Compensation Period controls user access to the system, in the preferred embodiment. It is used by administrators to close the system to managers for data entry, during which time administrators can perform administrative activities on the data, and potentially take a “snapshot” of how the distribution process is proceeding.

In a preferred embodiment, the present invention contains a currency translation capability that permits users to distribute and view bonuses and bonus pool money in US dollars, as well as local currencies. If an amount is displayed or entered as a local currency, the amount may be converted and displayed/stored in US Dollars based on, e.g., the exchange rate established at the beginning of the Bonus Compensation Period. In other embodiments, all currency values are shown and entered in the local currency, whether the listed employees are paid in USD or another currency.

A preferred embodiment also allows for pre-pool distribution. In particular, managers are able to view their populations and model bonus payments. Each manager pool may be able to create a number (e.g., three) modeling scenarios. In this embodiment, one scenario is marked as “Master” at all times to allow for rollup and drilldown. Pools represent the available spend that is given to the managers. Managers fit one of their scenarios to the pool of money that they, eventually, receive. Numbers entered by managers at the lower levels of the hierarchy are rolled up to upper levels of the hierarchy and eventually up to the pool originator, thereby allowing all members of the management chain to review the activities of those in their reporting structure. Managers at upper levels of the hierarchy can drill down to their bonus managers to see how these managers plan to pay the people who report to them.

When an overspend flag is set to “on” in the system, the managers have no spending limit. If they go over the pool amount, the remaining pool amount is highlighted in red. When an overspend flag is set to “off”, managers must fit their master scenario within the pool limit. A tolerance factor (e.g., 0.01%) may be allowed for foreign exchange rate calculation/rounding issues. Bonus spend and pool distribution can happen in iterative cycles. Snapshots can be taken after each iterative cycle. Snapshots serve as a view as of a certain point in time. Once all managers sign off on the proposals for bonuses/salary, the administrator signs off for the division, and all bonus/salary numbers are sent to the human resources system.

The system also provides views to other populations (i.e., employees not within a manager's reporting chain. In particular, lists of other employees can be generated, thereby allowing managers outside such employees' management chain to submit bonus/salary recommendations.

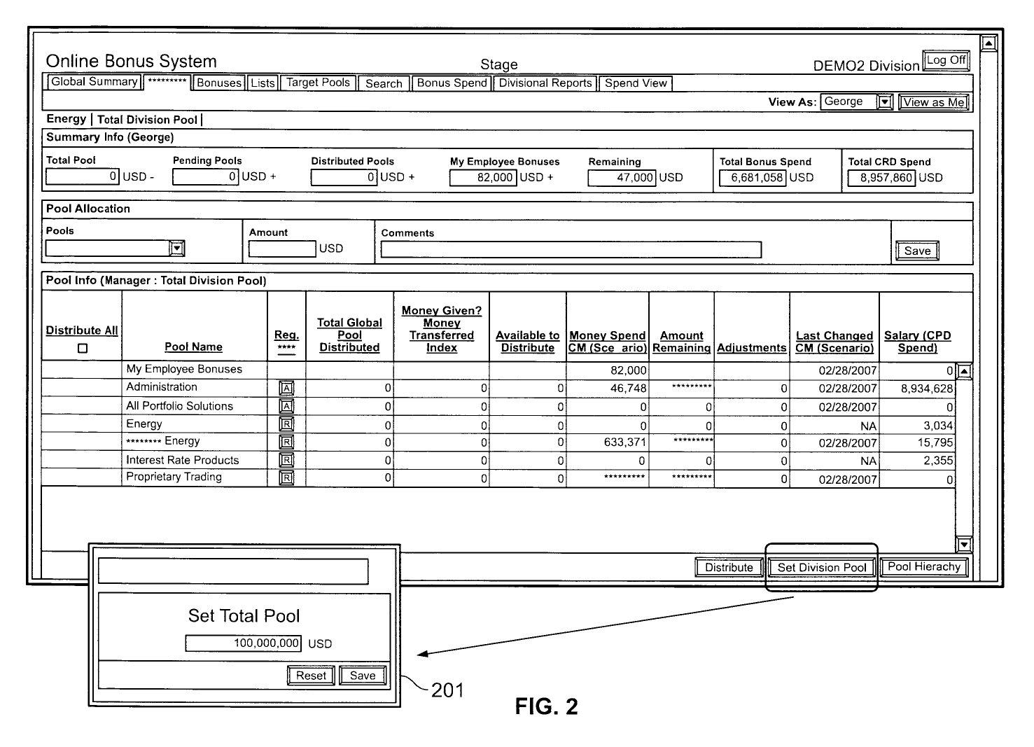

This, and other, exemplary functionality is described in more detail below with reference to FIGS. 2 through 19, illustrating screen shots that may be used in connection with the present invention.

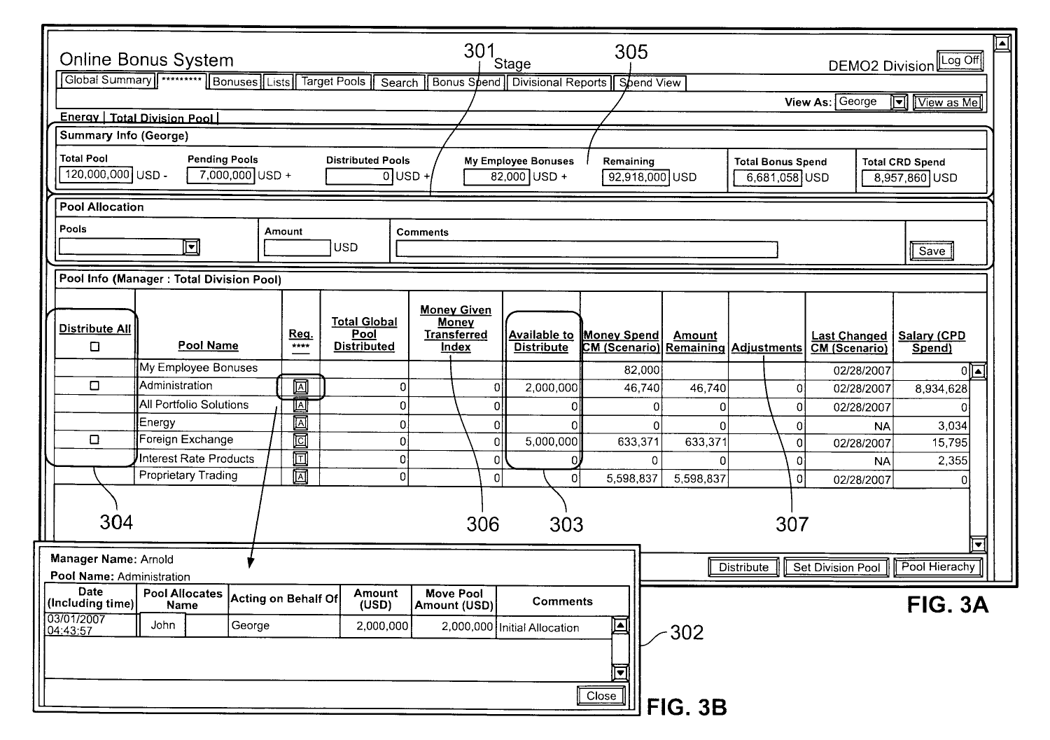

The Pool Originator is at the top of the pyramid, with the ability to set the total division pool and distribute pools to pool managers. Guarantees and advances are automatically accounted for in the Bonus Spend. With reference to FIG. 2, the Pool Originator can set the total division pool, using box 201. With reference to FIG. 3A, the Pool Originator can make an initial distribution to Pool Managers, see box 301, specifying (in USD) who gets the pool. A Registry 302, shown in FIG. 3B, tracks the date/time, pool allocator/amount, and any comments. Pending Distribution 303 represents pool money sitting in pending status until the pool is distributed. Distribute/Distribute All 304 allows for the selective distribution of pools to Pool Managers and Bonus Managers. An email is sent to the receiving manager and pending amounts are moved to the distributed column. Summary info 305 indicates the pool amount saved for direct reports, the pool amount distributed to direct reports, and the amount spent on staff bonuses. The Money Given Index 306 indicates the difference between initial pool and current pool. Adjustments 307 accounts for pool changes as a result of moving money.

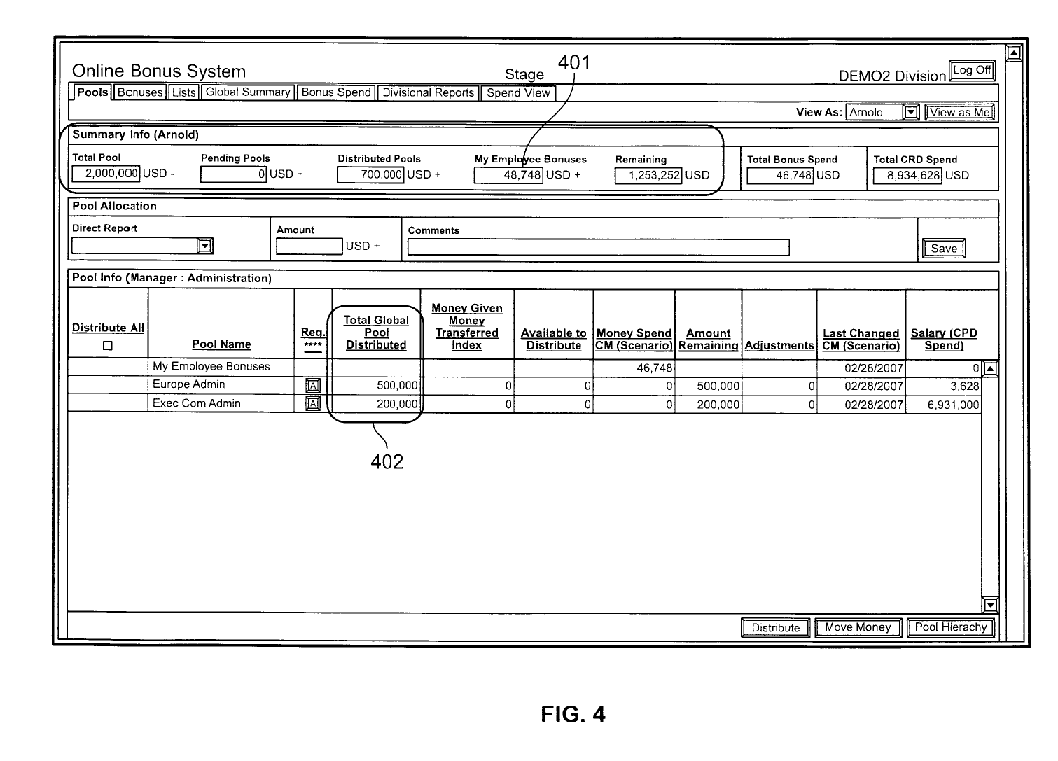

The Pool Manager distributes pools to other Pool Managers and Bonus Managers. With reference to FIG. 4, this second level of pool distribution is illustrated. Summary info 401 identifies pool amounts saved for direct reports and pool amounts distributed to direct reports. The Total Pool Distributed 402 is also indicated.

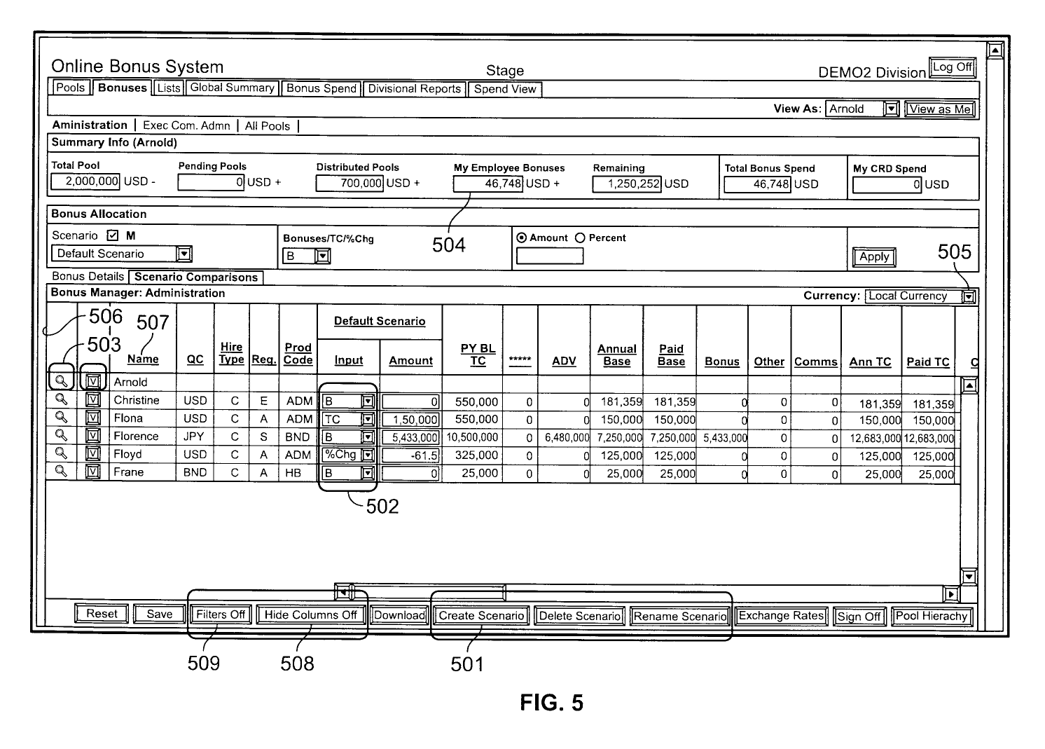

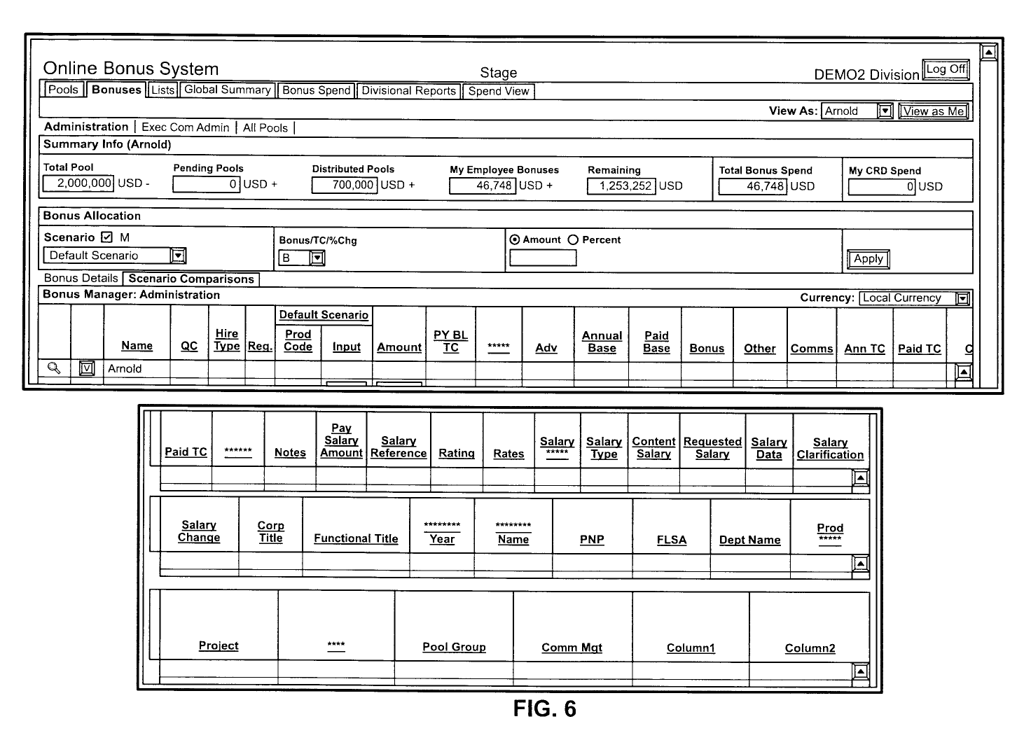

With reference to FIG. 5, an exemplary Bonus Manager screen is shown. Bonus managers distribute bonuses to direct reports. With reference to box 502, Bonus Amount, Total Compensation or % Change is shown. An Employee Detail Screen may be accessed by clicking on the magnifying glass 503. Bonuses 504 indicates saved bonuses for direct reports; remaining amounts are re-calculated automatically. Area 506 is the horizontal scroll area which displays compensation and job data. The user may download the horizontal scroll area into a spreadsheet. With reference to FIG. 6, the full horizontal scroll area is shown. Data is available in a local currency view as well as a USD view. Tabs for local currency 505 will not be shown if direct reports are all paid in USD. Tabs will be present if direct reports are paid in varying currencies. Bonus amounts must be entered on Employee Currency tab. Different font colors may be shown for direct reports who are also Pool Managers or Bonus Managers. Clicking on a direct report 507 will drill down to that manager's view of his/her direct reports.

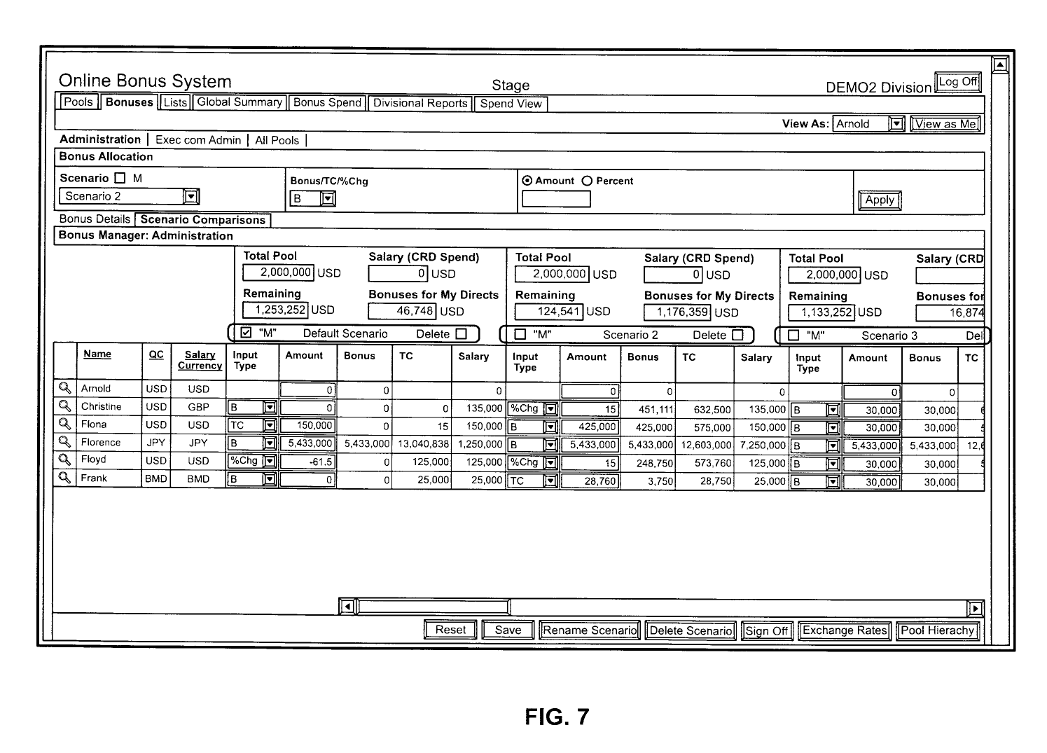

With reference to FIG. 7, a screen that allows for scenario modeling is shown (see Create Scenarios Button 501 of FIG. 5). A Default Scenario is automatically created for each manager. Guarantees and advances are pre-populated.

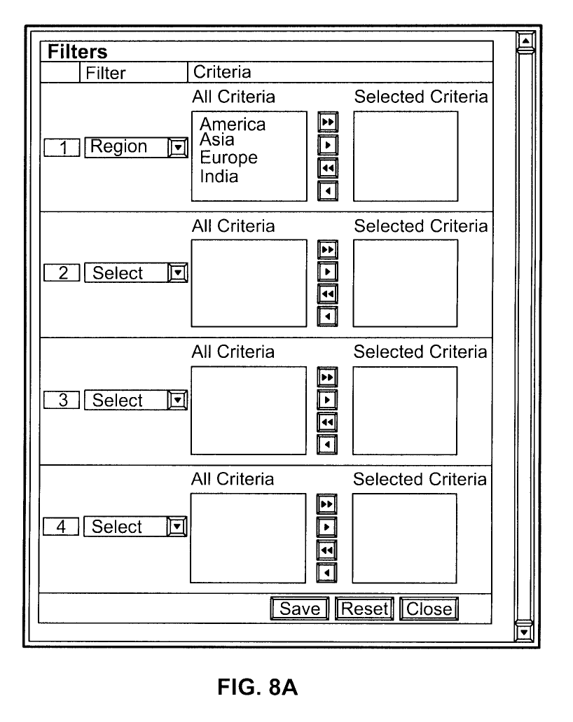

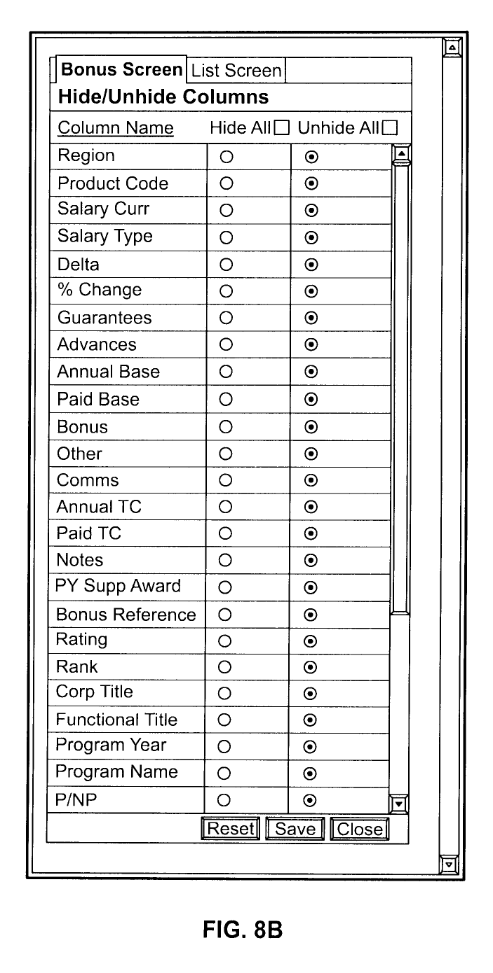

With reference to FIGS. 8A and 8B, the Filter and Hide/Unhide screens are shown (see Filter button 509 and Hide/Unhide button 508 of FIG. 5). This allows the user to filter the population by selected fields in the horizontal scroll. Also, the user can hide selected columns in the horizontal scroll. Hide/unhide options can be set for the Bonuses screen and/or Lists screen.

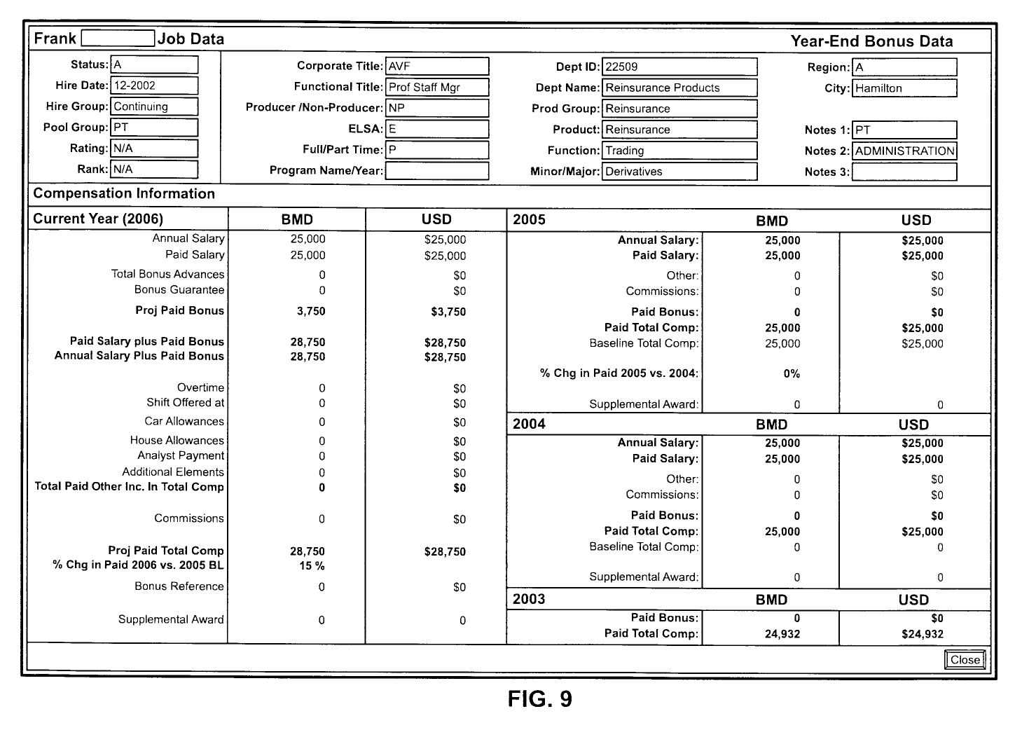

With reference to FIG. 9, the Microscreen is shown. This screen provides detailed compensation information for a given employee.

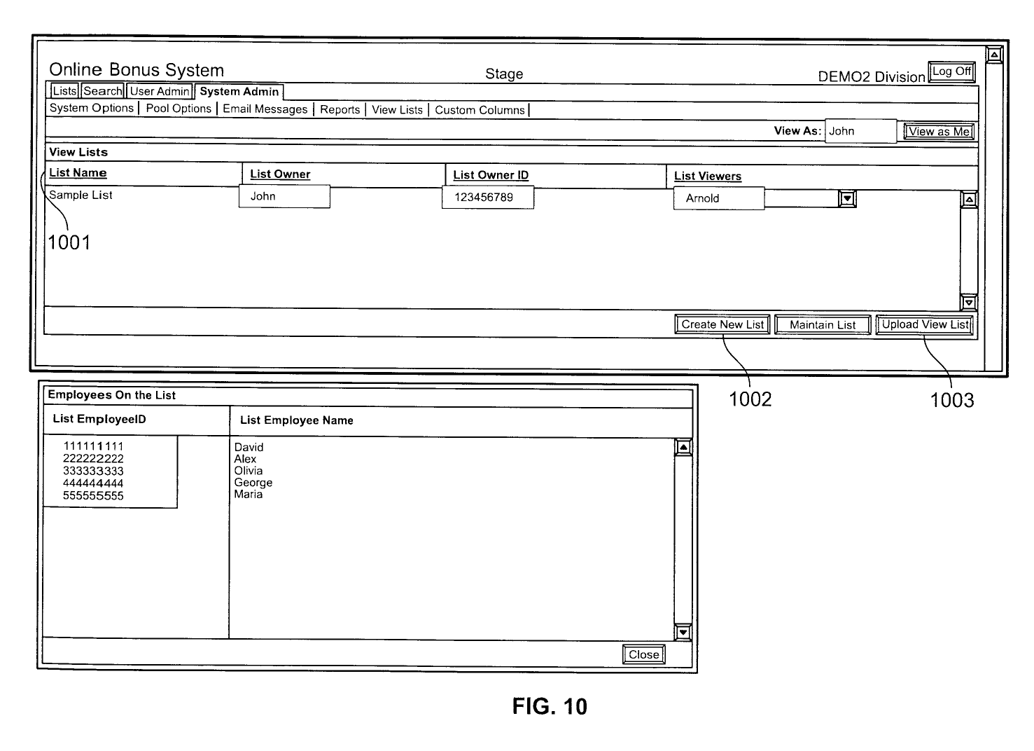

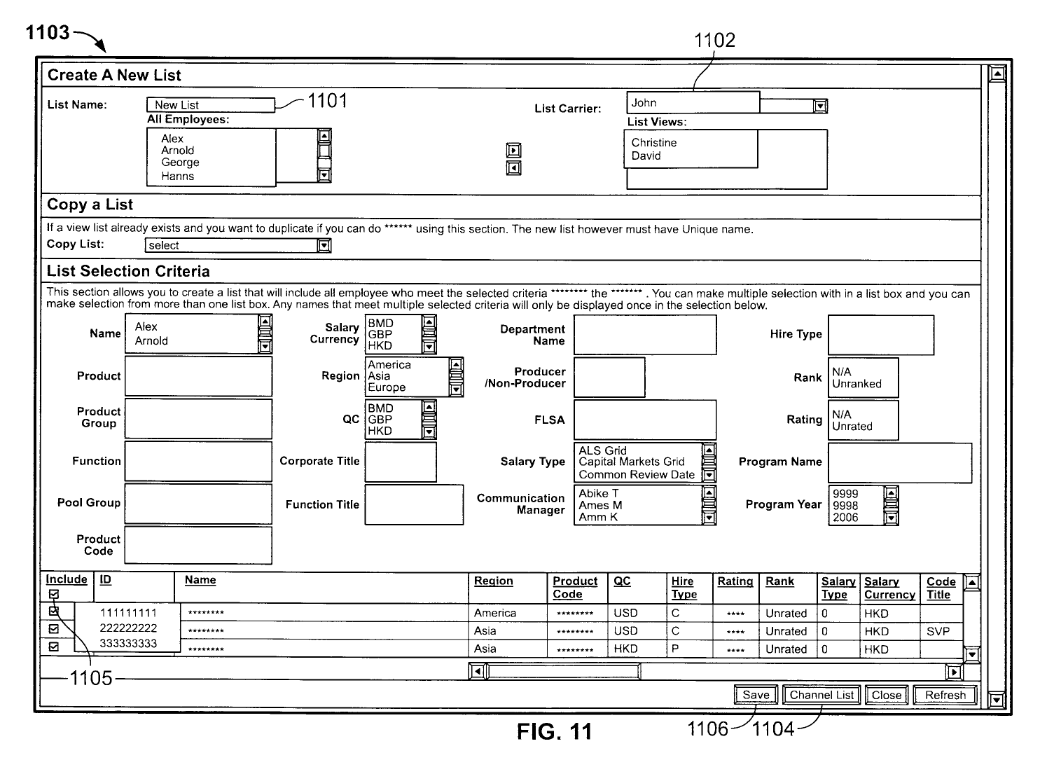

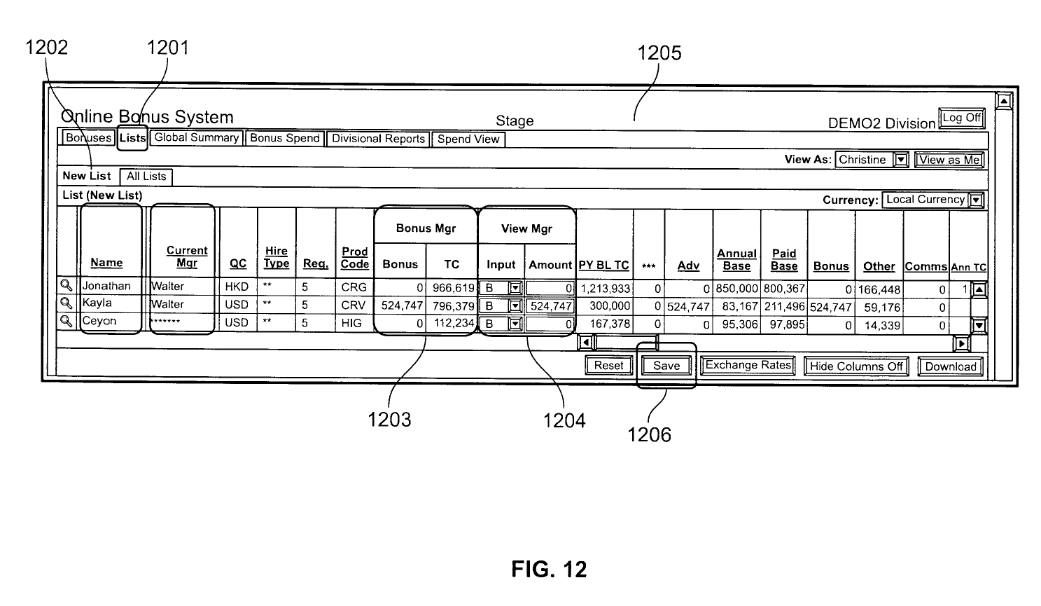

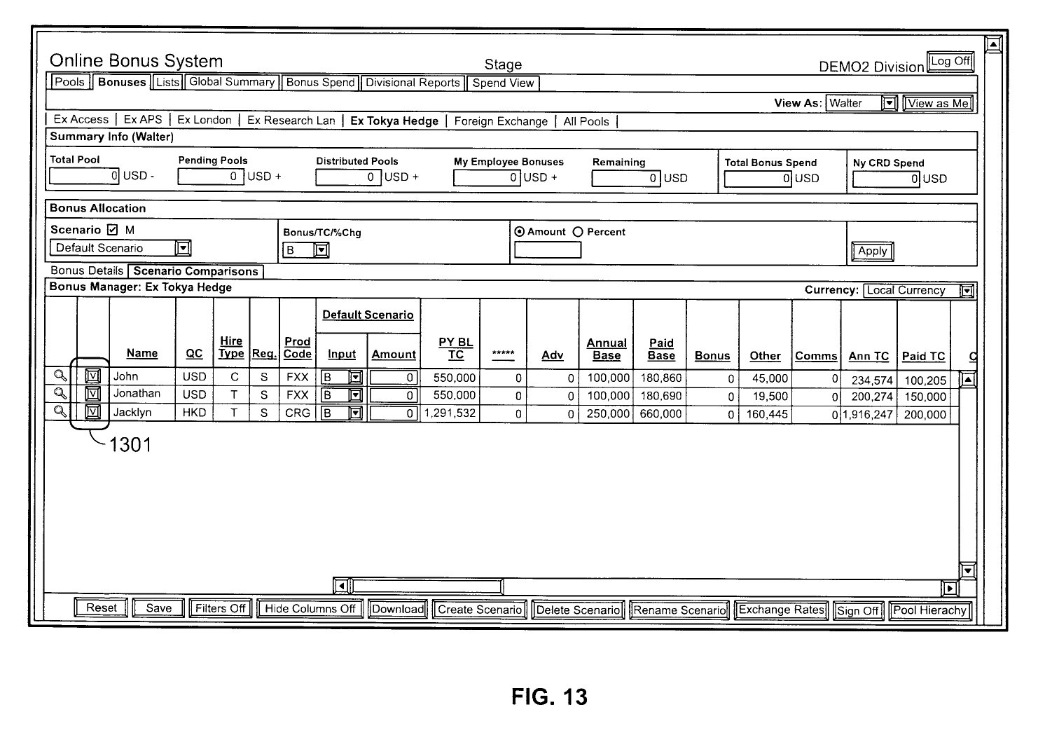

The List Manager has view access to a predefined list of employees and can submit bonus and salary recommendations for those employees. With reference to FIG. 10, the List Screen is shown. Clicking on the List Name 1001 will pop-up a screen with employees on the list. Lists can be created and maintained online (see button 1002). Lists can also be uploaded into the system (see button 1003). With reference to FIG. 11, a List Creation Screen is shown. This allows for the entering of a list name (button 1101); assigning the list owner and list viewers (area 1102); selecting list criteria (area 1103); click generating a list (button 1104); select the employees from the generated list to save to the final list (button 1105); and save the list (button 1106). With reference to FIG. 12, recommendations can be made (area 1205). The Select the Lists tab 1201 is indicated, allowing the user to select the list and name to view (area 1202). The employee's Bonus Manager is indicated and the employee's Bonus Manager's input is displayed in area 1203. Recommendations for bonuses and salaries can be made and saved (areas 1204 and 1206). With reference to FIG. 13, recommendations can be reviewed. The V button 1301 is activated if the employee has bonus and salary recommendations from managers. The V button 1301 is clicked to view the recommendations.

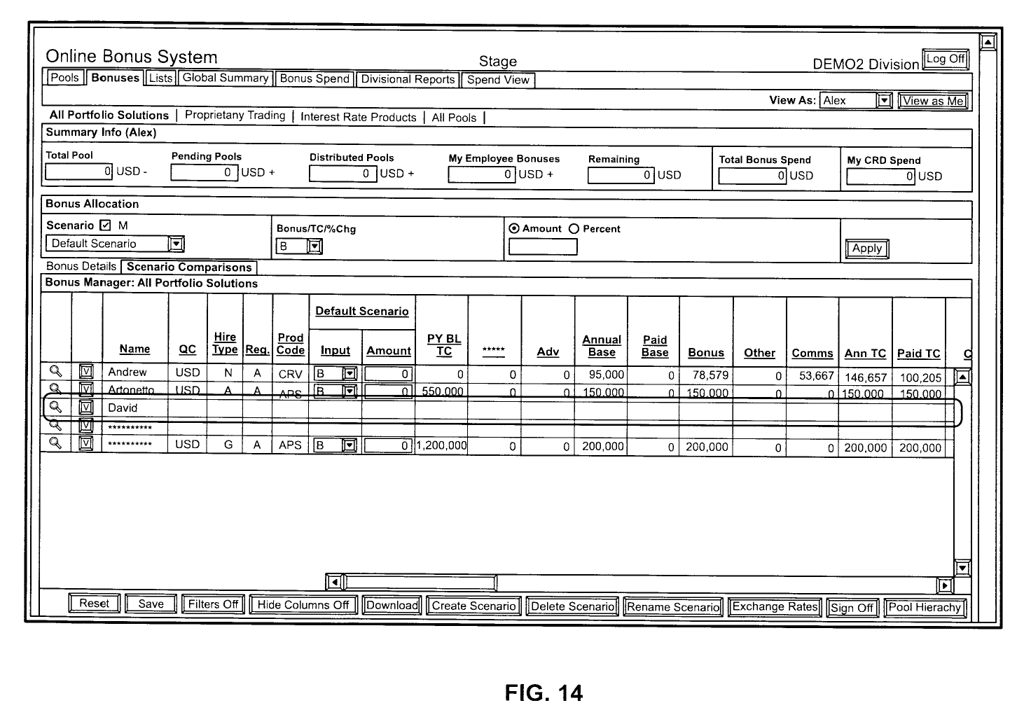

With reference to FIG. 14, Payment Agents are listed on the distributing manager's Bonuses screen to allow drilldown to the population. A Payment Agent gets a pool for distributing bonuses to direct reports; he is not included in headcount or paid by the distributing manager. No other information is displayed for the Payment Agent because he is not paid by this manager; in the illustrated exemplary embodiment, Payment Agents are listed on the pool screen for drill-down purposes only. Payment Agent's Pools and Bonuses screen look like that of any other Pool Manager or Bonus Manager.

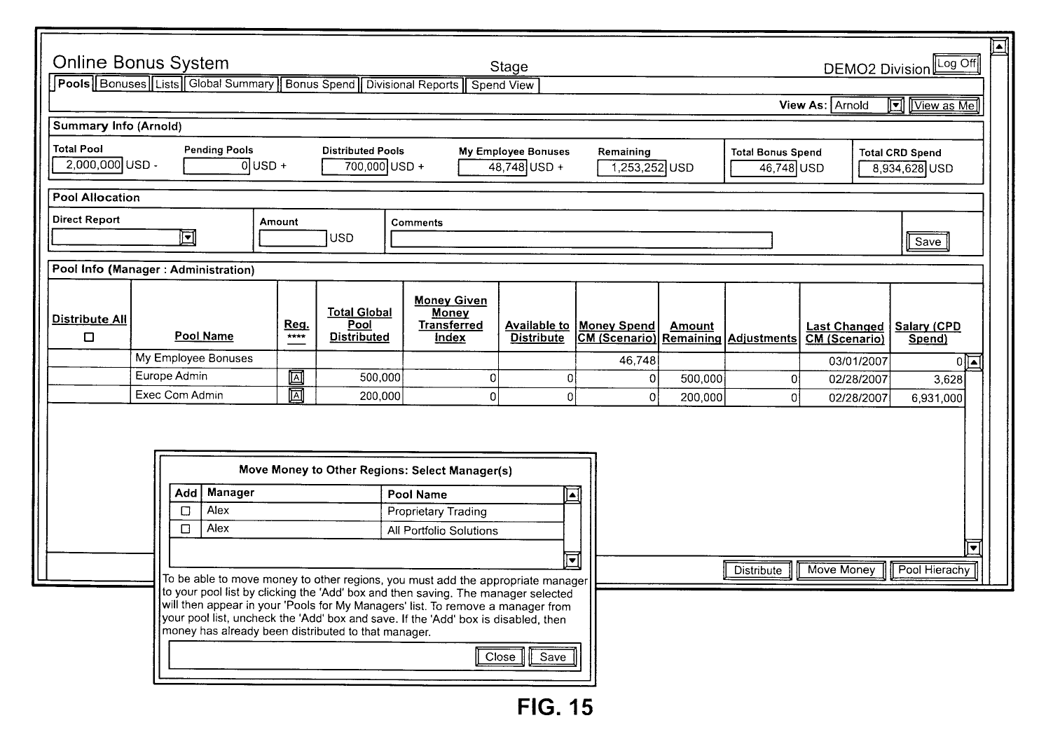

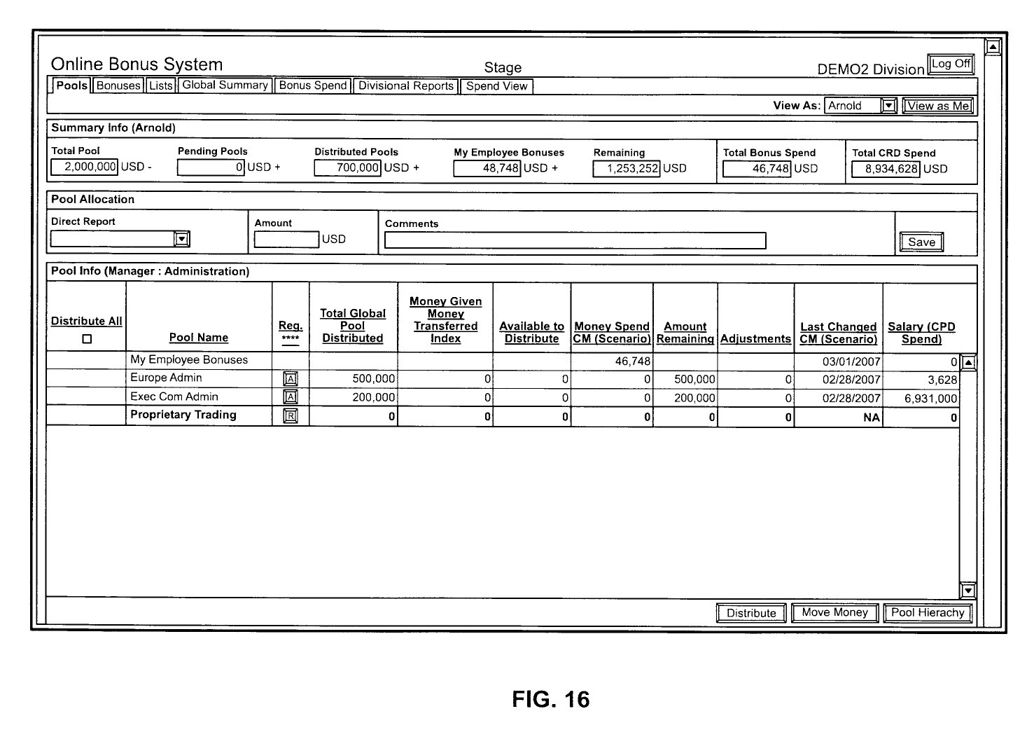

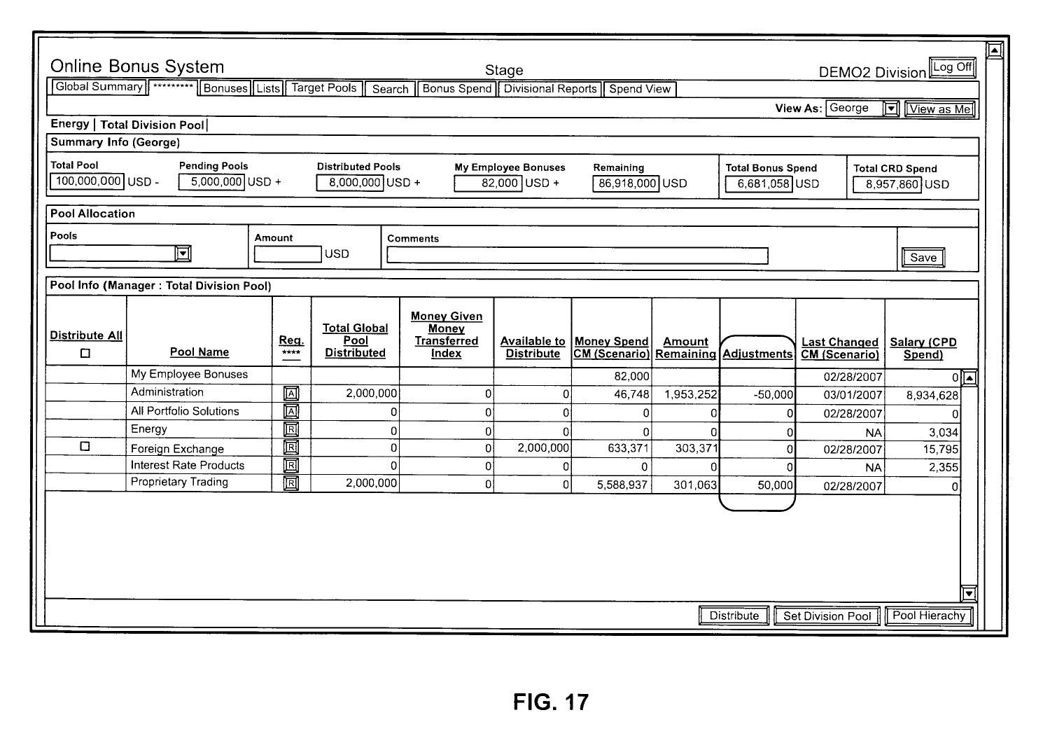

With reference to FIG. 15, a screen and accompanying pop-up screen is shown that enables the moving of money. This enables the receiving manager to receive funds. Privileges for moving money are set up by a user administrator. With reference to FIG. 16, a move money distribution is shown. The recipient of move money will appear in a different font color. When money is moved, the Total Global Pool Distributed and Money Transferred Index columns are updated. With reference to FIG. 17, an upper level manager's view of the move money functionality is shown.

A Co-Manager is a co-owner of a pool who can view the primary manager's payment scenarios, but needs to coordinate with the primary owner of the pool to submit/finalize numbers. A Viewing Manager is pertinent to single pools only. This manager has view access to employee(s) and the hierarchy associated with the employee(s). The viewing manager hierarchy is separate and distinct from the bonus paid hierarchy. A Global Administrator manages system and user setup and may work on behalf of Pool Originators, Pool Managers and Bonus Managers. A Regional or Product Administrator may manage selective system and user setup options and may work on behalf of Pool Managers and Bonus Managers for a pre-defined region or product code. A Pool Administrator may work on behalf of Pool Managers and Bonus Managers in a leg of the hierarchy (e.g., a pool) for the purpose of keeping the process moving along; this administrator has no system or user setup access.

As will be apparent to those skilled in the art, the titles/roles and capabilities described for the various managers/administrators herein is for exemplary purposes only. Other titles/roles and associated capabilities can be used within the scope of the present invention.

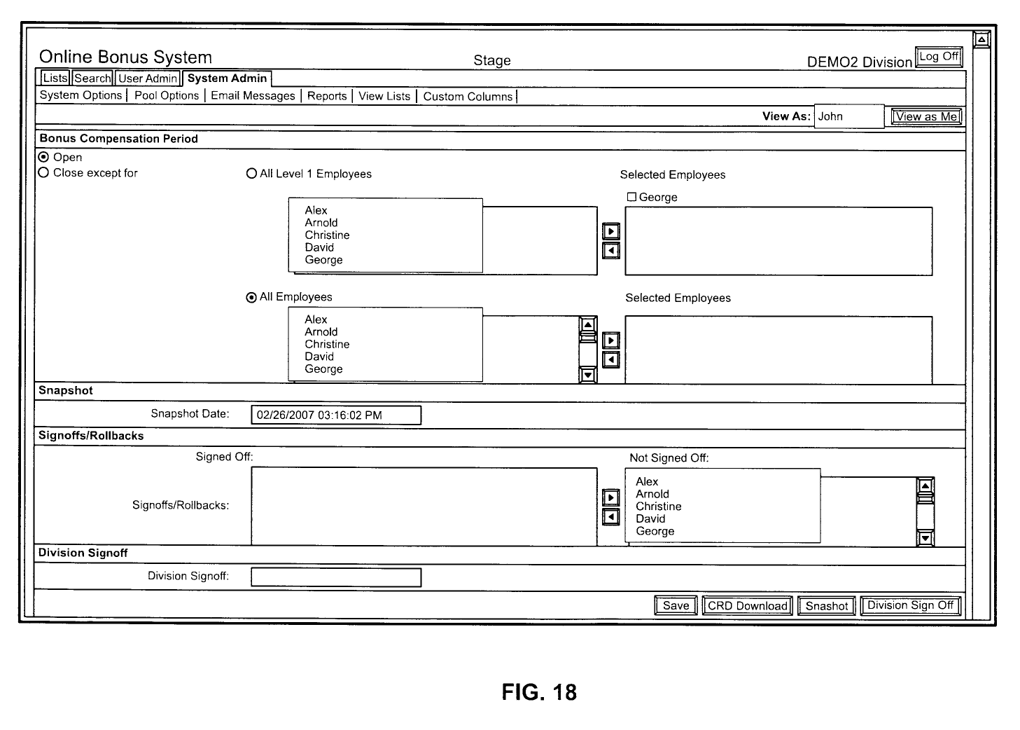

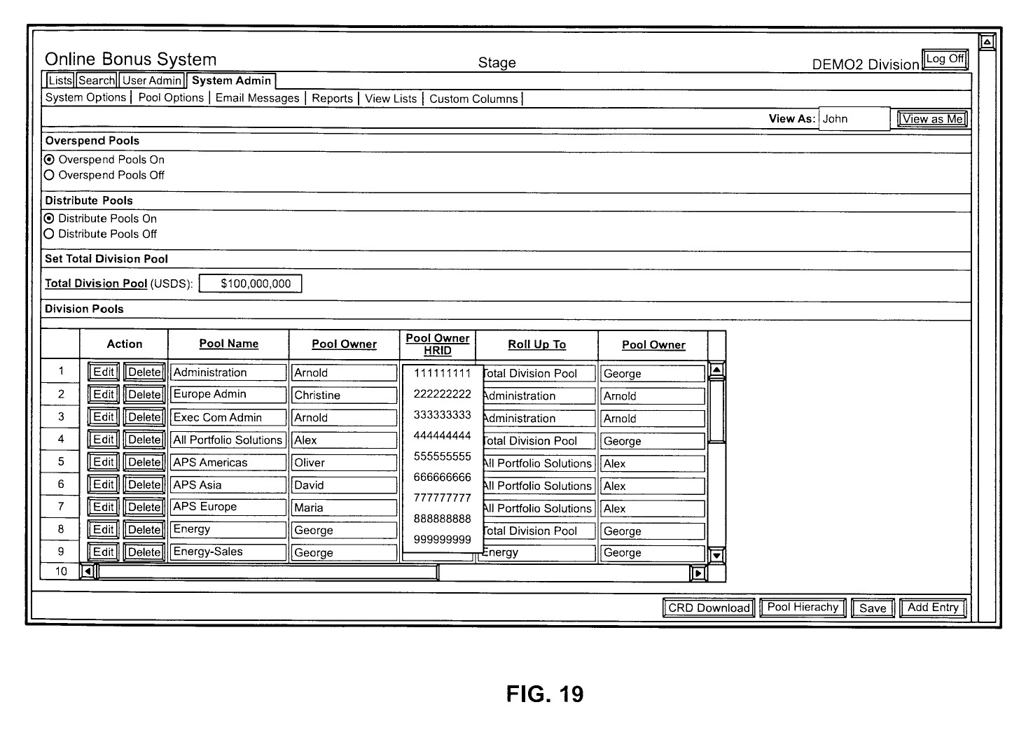

FIGS. 18 and 19 are exemplary screens that can be used to implement administrative functionality of the system. FIG. 18 is a screen allowing for the opening and closing of the Bonus Compensation Period. The date and time of a Snapshot can also be identified using this screen. Also shown are the managers who have signed off, or not, on the proposed bonus/salary allocations, as well as whether there has been any sign off by the division head. FIG. 19 is a screen that allows the overspend to be turned on or off, and allows for the distribution of pools to be turned on or off. The Total Division Pool can be set using this screen, and a list of division pools, and related information, is shown.

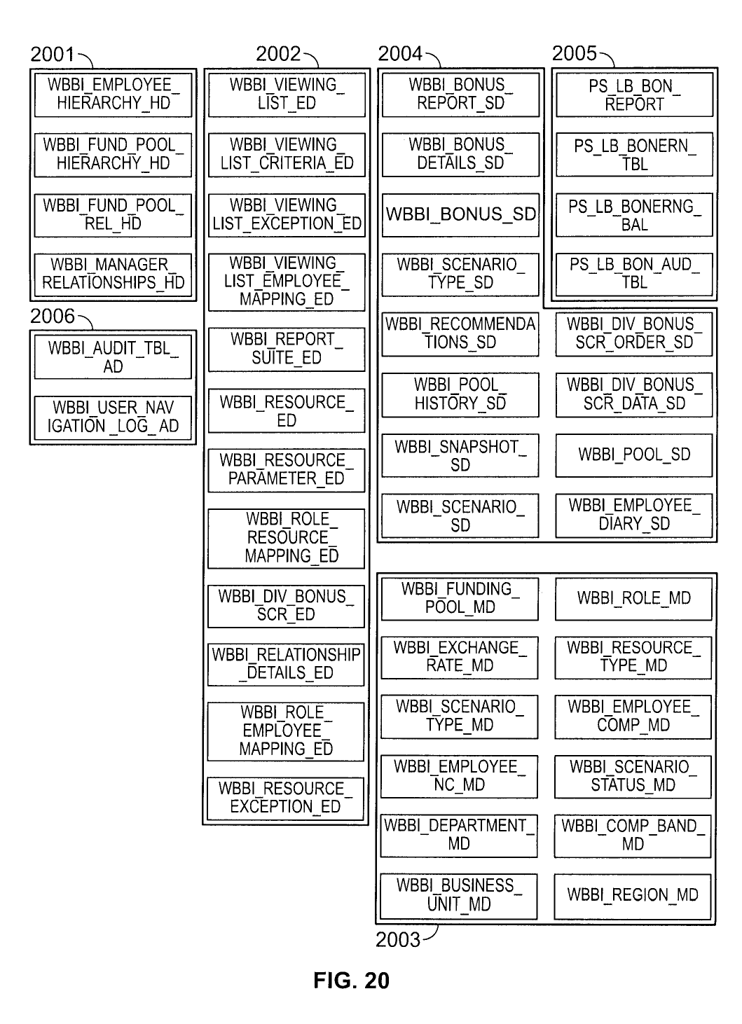

In a preferred embodiment, database used to store the bonus application related information is an Oracle database (see database 106 of FIG. 1). Also in the preferred embodiment, this database resides in the same database instance, with the same schema as the database used to house human resources information maintained via a human resources application. The exemplary database includes several main sections: hierarchy data; entitlement data; master data; audit data; scenario data (which includes Pool and Bonus Data); and global bonus data. An exemplary database schema is shown in FIG. 20, identifying the names of the various tables and the groupings into which they fall.

Tables 2001 are used to organize the hierarchy information.

Tables 2002 are used to organize entitlement data. In particular, VIEWING_LIST_ED defines the viewing list available in the system. These lists will help adminstrators in defining the viewing hierarchy. VIEW_LIST_EMP_MAPPING_ED maps the person belonging to the list with the list. VIEW_LIST_VIEWRS_ED also serves to map the person belonging to the list with the list. REPORT_SUITE_ED stores the various report suites that are available. These are aggregates of reports. RESOURCE_ED defines the resources present within the system. RESOURCE_PARAMETER_ED defines the parameters that need to be passed for a particular resource. ROLE_RESOURCE_MAPPING_ED stores the mapping of roles and resources. ROLE_EMPLOYEE_MAPPING_ED stores the mapping of employees to roles. RESOURCE_EXCEPTION_ED stores the exceptions to the criteria which define the viewing list available in the system. DIV_BONUS_SCR_ED lists the various columns that can be available on the My Bonus screen depending on the divisions. EMP_HIDDEN_COLUMNS_ED maps to hidden column name in the html table of the jsp.

Tables 2003 are used to organize master data. BUSINESS_UNIT_MD_VIEW is the master view for the Division, which stores, in addition to the division names, the contact, pool owner information, etc. REGION_MD_VIEW is the master table for the region. This can be a view directly from the human resources application. DEPARTMENT_MD_VIEW is the master table for the department. This can be a view directly from the human resources application as well. COMP_BAND_MD stores the compensation bandings. This table is used to generate reports and list the employees in compensation bands based on their compensations. EXCHANGE_RATE_MD_VIEW is the master table for the exchange rates to be used within the system. It is derived from the human resources application. EMPLOYEE_MD contains information for all employees. EMPLOYEE_TYPE_MD is used as employee type master, which will basically describe employee types. SCENARIO_TYPE_MD contains possible values for scenario types. SCENARIO_STATUS_MD contains possible values for scenario status. FUNDING_POOL_MD contains all FUNDING_POOL related information for all divisions. The FUNDING_POOL_OWNERSHIP_MD should have Owner and may have one or more Co-owners. ROLE_MD defines the roles available in the system. RESOURCE_TYPE_MD stores the various types of resources available to a system. Resources can be tabs, report suites, reports etc. SERVICE_INTERVAL_MD stores the service intervals for all divisions. EMAIL_MESSAGES_MD stores data for email messages screens.

Tables 2004 are used to organize scenario data for pools and bonuses. POOL_SD contains Pool-related information for all Snapshots and Scenarios. The Pools are categorized by various FUNDING_POOLs. POOL_HISTORY_SD contains information about the individual pool transactions. The table is the source for the Registry popup on the Pools for my Managers screen. The table records information like the person who transferred the pool, the amount, the comments and date/time stamp for transactions. SNAPSHOT_SD contains all Snapshots created for all divisions. The current snapshot can be determined by checking the IS_CURRENT flag. When the snapshot is created by a divisional personnel from human resources, all the Pool and Bonus data will be snapshot on the respective tables with the newly created SNAPSHOT_ID. SCENARIO_SD contains all Scenario related information for all divisions. RECOMMENDATIONS_SD is the recommendations table which holds either Bonus or Total Comp recommendations made by other managers. EMPLOYEE_DIARY_SD contains diary information for all employees. DIV_BONUS_SCR_ORDER_SD stores the order of values in the columns that are defined in the DIV_BONUS_SCR_ED table. DIV_BONUS_SCR_DATA_SD stores the values for each of the employees in the columns described in DIV_BONUS_SCR_ED. BONUS_SD is the scenario table for the corresponding PS_LB_BONERN_TBL table. BONUS_DETAILS_SD is the scenario table for the corresponding PS_LB_BONERNG_BAL table. This table has all the different types of Bonus earnings for the employee for the fiscal year. It has data both in local currency and quote currency. BONUS_REPORT_SD is the scenario table for the corresponding PS_LB_BON_REPORT table. This table has all the employee details used for reporting. Each employee has two lines; one line has all figures in USD, the other line has all figures in quote currency. BUSINESS_UNIT_OPTIONS_SD stores additional data related to the division names the contact, pool owner information, etc. HIRE_CATEGORY_VIEW holds data for the Hire category. ALT_PRODUCT_CODE_VIEW holds data for the product code. SALARY_VIEW holds data for the salary indicator and its description. TITLE_VIEW holds data for the corporate title description. JOBCODE_VIEW holds data for the Job code and its description. PROGRAM_VIEW holds data for the program name description. PNP_VIEW holds data for the PNP code and its description. FLSA_STATUS_VIEW holds data for the FLSA code and its description. ALT_ORG_PRGP_VIEW holds data for the Organization PRGP code and its description. ALT__ORG_FUNCTION_VIEW holds data for the Organization function code and its description. CURRENCY_VIEW holds data for the currency code and its description.

Tables 2006 are used to organize audit information.

Tables 2005 are the global bonus tables present in the human resources application database. BONERN_TBL is the parent of BONERNG_BAL and has summary level employee information about indicators, restricted stock units, and options. BONERNG_BAL, has all the different types of Bonus earnings for the employee for the fiscal year. It has data both in local currency and quote currency. BON_REPORT has all the employee details used for reporting. BON_EMPDATA has all the employee non comp details for each fiscal year and some flags which indicate what Data has been updated. BON_OVERRIDE has all the different types of Bonus earnings for the employee for the fiscal year that has been over-written. This data flows to the BONERNG_BAL table as an override amount. This data is in local currency. BON_ERNACM1 is a setup table that links the two fields BONCAT_ID and BONCAT_TYPE. SYS_CONTROL is a setup table to indicate the current Bonus year. XRT_TBL is the table that has the conversion rate between other currencies and USD. SAL_PROG is the table which holds the various salary programs. SAL_GRID is the table which holds the grid information corresponding to the various salary programs. STK_PROG is the table which holds the various stock programs. STK_GRID is the table which holds the grid information corresponding to the various stock programs. BON_AUD_TBL is the table from the human resources application that has the audit info for the Global bonus data changes.

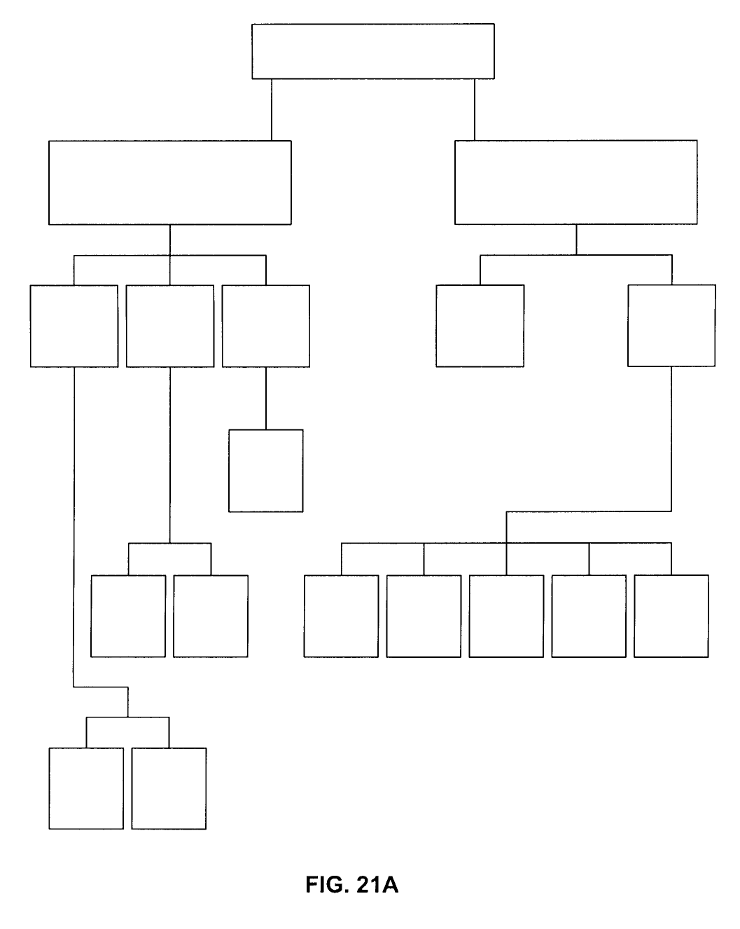

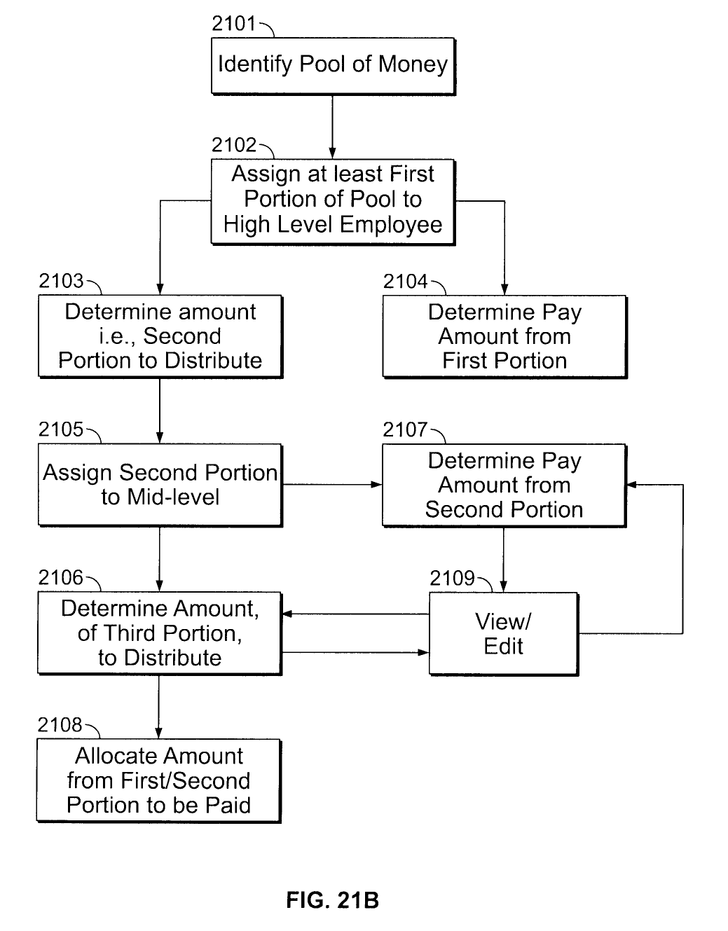

With reference to FIGS. 21A and 21B, a method and system for determining compensation to be paid to one or more employees of an organization is illustrated. With reference to FIGS. 21A, the organization is comprised of a plurality of employees organized in accordance with a hierarchical structure comprising one or more high-level employees, one or more mid-level employees below the high-level employees in the hierarchical structure, and one or more low-level employees below the mid-level employees in the hierarchical structure. With reference to FIG. 21B, a pool of money to be paid to the employees in the organization as compensation is identified in step 2101. At least a first portion of the pool is assigned to the high-level employee in step 2102. Upon being assigned the first portion, the high-level employee determines a second portion of the pool from the first portion to be distributed to one or more employees below the high-level employee in the hierarchical structure, in step 2103, and/or an amount from the first portion to be paid to one or more employees below the high-level employee in the hierarchical structure, in step 2104. The second portion of the pool is assigned to the mid-level employee in step 2105. Upon being assigned the second portion, the mid-level employee determines a third portion of the pool from the second portion to be distributed to one or more employees below the mid-level employee in the hierarchical structure, in step 2106 and/or an amount from the second portion to be paid to one or more employees below the mid-level employee in the hierarchical structure in step 2107. The low-level employee is allocated the amount from the first portion and/or the amount from the second portion to be paid as compensation, in step 2108. The high-level employee is provided view and/or edit access to the third portion and/or the amount from the second portion, in step 2109. One or more of the foregoing steps may be performed by software running on a data processing apparatus.

The present invention is intended to embrace all alternatives, modifications and variances that fall within the scope of the appended claims.

What is claimed is:

1. A method for determining compensation to be paid to one or more members of an organization, wherein the organization is comprised of a plurality of members organized in accordance with a hierarchical structure comprising one or more first-level members, one or more second-level members below the first-level members in the hierarchical structure, and one or more third-level members below the second-level members in the hierarchical structure, the method comprising:
(A) identifying a pool of money to be paid to the one or more members in the organization;
(B) assigning at least a first portion of the pool to the one or more first-level members,
wherein, upon being assigned the first portion, the one or more first-level members determine one or more of (i) a second portion from the first portion of the pool to be distributed to one or more members below the one or more first-level members in the hierarchical structure; and (ii) an amount from the first portion to be paid to one or more members below the one or more first-level members in the hierarchical structure;
(C) assigning the second portion of the pool to the one or more second-level members,
wherein, upon being assigned the second portion, the one or more second-level members determine one or more of (i) a third portion from the second portion of the pool to be distributed to one or more members below the one or more second-level members in the hierarchical structure and (ii) an amount from the second portion to be paid to one or more members below the one or more second-level members in the hierarchical structure;
(D) paying to the one or more third-level members one or more of (i) the amount from the first portion and (ii) the amount from the second portion; and
(E) providing the one or more first-level members with one or more of (i) view access and (ii) edit access by way of an interface to one or more of (a) the third portion and (b) the amount from the second portion.

2. The method of claim 1 wherein the money is viewable in a plurality of different currencies.

3. A system for determining compensation to be paid to one or more members of an organization, wherein the organization is comprised of a plurality of members organized in accordance with a hierarchical structure comprising one or more first-level members, one or more second-level members below the first level members in the hierarchical structure, and one or more third-level members below the second-level members in the hierarchical structure, the system comprising:
one or more servers that receive communications from a user over a communications network;
one or more databases that store member-related data, comprising member compensation data;
an interface through which the user can access the one or more servers over the communications network to
identify a pool of money to be paid to the one or more members in the organization;
assign at least a first portion of the pool to the one or more first-level members,
wherein, upon being assigned the first portion, the one or more first-level members determine one or more of (i) a second portion from the first portion of the pool to be distributed to one or more members below the one or more first-level members in the hierarchical structure; and (ii) an amount from the first portion to be paid to one or more members below the one or more first-level members in the hierarchical structure;
assign the second portion of the pool to the one or more second-level members,
wherein, upon being assigned the second portion, the one or more second-level members determine one or more of (i) a third portion from the second portion of the pool to be distributed to one or more members below the one or more second-level members in the hierarchical structure and (ii) an amount from the second portion to be paid to one or more members below the one or more second-level members in the hierarchical structure;
paying to the one or more third-level members one or more of (i) the amount from the first portion and (ii) the amount from the second portion; and
provide the one or more first-level members with one or more of (i) view access and (ii) edit access by way of the interface to one or more of (a) the third portion and (b) the amount from the second portion.

4. The system of claim 3 wherein the money is viewable in a plurality of different currencies.

5. A computer-readable medium comprising instructions which, when executed on a processor, perform a method for determining compensation to be paid to one or more members of an organization, wherein the organization is comprised of a plurality of members organized in accordance with a hierarchical structure comprising one or more first-level members, one or more second-level members below the first-level members in the hierarchical structure, and one or more third-level members below the second-level members in the hierarchical structure, the method comprising:
(A) identifying a pool of money to be paid to the one or more members in the organization;
(B) assigning at least a first portion of the pool to the one or more first-level members,
wherein, upon being assigned the first portion, the one or more first-level members determine one or more of (i) a second portion from the first portion of the pool to be distributed to one or more members below the one or more first-level members in the hierarchical structure; and (ii) an amount from the first portion to be paid to one or more members below the one or more first-level members in the hierarchical structure;
(C) assigning the second portion of the pool to the one or more second-level members,
wherein, upon being assigned the second portion, the one or more second-level members determine one or more of (i) a third portion from the second portion of the pool to be distributed to one or more members below the one or more second-level members in the hierarchical structure and (ii) an amount from the second portion to be paid to one or more members below the one or more second-level members in the hierarchical structure;
(D) paying to the one or more third-level members one or more of (i) the amount from the first portion and (ii) the amount from the second portion; and
(E) providing the one or more first-level members with one or more of (i) view access and (ii) edit access to one or more of (a) the third portion and (b) the amount from the second portion by way of an interface.

6. The computer-readable medium of claim 5 wherein the money is viewable in a plurality of different currencies.
